(19) United States
(12) Patent Application Publication
(10) Pub. No.: US 2010/0276229 A1
(43) Pub. Date: Nov. 4, 2010

(54) Lubricant and Method of Using Same

(76) Inventor: Steven J. Winckler, Middle Grove, NY (US)

Correspondence Address: GFD PATENTS, LLC, P.O. BOX 752, CLIFTON PARK, NY, 12065, US

(21) Appl. No.: 12/772,984

(22) Filed: May 3, 2010

Related U.S. Application Data
(60) Provisional application No. 61/174,534, filed on May 1, 2009.

(51) Int. Cl. F16N 7/00; C10M 173/00; C10M 105/76; B08B 3/00

(52) U.S. Cl. 184/15.1; 508/110; 508/207; 508/173; 508/508; 508/524; 508/406; 508/244; 134/34

(57) ABSTRACT

A lubricant and method for cleaning a drive chain of an apparatus, such as a bicycle or motorcycle. The lubricant of the present invention comprises a water miscible lubricating material, that will tend to stay on the chain during dry, and typical wet condition encountered on a bicycle, yet enable the removal with a direct blast from a solvent. The method for cleaning the drive chain comprises providing the solvent, such as any polar liquid, such as water. A continuous supply of clean solvent may be available from a source, such as a common garden hose or bottle. Forceful spraying onto the first surface in the direction of the arrows removes lubricant that is contaminated with dirt and/or sand from the first surface of the chain to form a layer of solvent and contaminated lubricant on the ground upon which the apparatus is supported or rides.

### CROSS-REFERENCE TO RELATED APPLICATIONS

This application is a non-provisional application, which claims the benefit of priority to U.S. provisional application Ser. No. 61/174,534, filed on May 1, 2009, the contents of each of which are herein incorporated by reference.

### FIELD OF INVENTION

The present invention is generally related to lubricants for drive chains. More specifically, the present invention is related to surface lubricants for bicycle chains that may be washed from the chain's surface to remove dirt, sand or accumulated metal filings.

### BACKGROUND

It is generally accepted that keeping a drive chains clean and lubricated is important to chain performance and life, in all machines that use them. Cleaning a bicycle chain is generally a difficult and dirty job. In one typical method of cleaning, the chain may be removed from the bicycle, and cleaned with a parts washing machine; such as those generally used to clean automotive parts. These parts washing machines provide a means to deliver dirt and/or sand free solvent to the chain, a basin to catch the solvent and provide an area to apply cleaning action (i.e. brushing) to the chain. The solvent helps mobilize the lubricants and transport dirt and sand out of the chain.

It is important attribute of these machines to deliver a dirt and/or sand free stream of solvent (usually recycled through a solvent cleaning system) to the chain, because dirty solvent will only reintroduce dirt and sand back onto the chain. The chain is then dryed, lubricated and reinstalled on the bicycle.

Problems associated with typical methods of cleaning is they are time consuming, and they require mechanical expertise to remove and reinstall the chain, and they may require an expensive parts washer cleaning system. Therefore, there is a need for a lubricant and method of cleaning the lubricant off a surface of a chain when the lubricant becomes contaminated with dirt and/or sand.

### BRIEF DESCRIPTION OF THE FIGURES

FIG. 1 depicts a side cross-sectional view of an apparatus having a drive chain, such as the drive chain of a bicycle or motorcycle, having a lubricant contaminated with dirt and/or sand thereon, in accordance with embodiments of the present invention; and

FIG. 2 depicts an expanded view of the side cross-sectional view of the chain, illustrated in FIG. 1, wherein the contaminated lubricant has been washed off the surface of the chain, in accordance with embodiments of the present invention.

### SUMMARY OF THE INVENTION

A first aspect of the present invention provides a coating for the drive chain of a bicycle or motorcycle, comprising a semi water-soluble lubricant.

A second aspect of the present invention provides a drive chain lubricant, wherein the drive chain is for power transfer, comprising: a water miscible mixture comprising a hydrocarbon or silicone; and an effective amount of surfactant to make the mixture homogeneous.

A third aspect of the present invention provides a method for washing a drive chain, wherein the drive chain is for power transfer, comprising: providing a drive chain, having a first surface, wherein the first surface has a semi water-soluble lubricant, thereon, wherein the semi water-soluble lubricant has been contaminated with dirt and/or sand; and essentially completely removing the contaminated lubricant by washing the first surface of the drive chain with flowing water from a hose, chain cleaning tool, or spray bottle.

A fourth aspect of the present invention provides a method for lubricating a drive chain, wherein the drive chain is for power transfer, comprising: exposing a first surface of the chain and wetting the first surface of the chain with water; and applying a semi water-soluble lubricant to the wetted first surface of the chain.

A fifth aspect of the present invention provides a drive chain lubricant, wherein the drive chain is for power transfer, comprising: a semi water-soluble lubricant; a water soluble rust inhibitor; and an effective amount of surfactant to make the mixture homogeneous.

### DETAILED DESCRIPTION OF THE EMBODIMENTS OF THE INVENTION

The invention meets a need in the art by providing a semi water-soluble lubricant to lubricate the drive chain on a bicycle or motorcycle and to enable the cleaning of a drive chain on the bicycle or motorcycle, without the need for degreaser fluids or complicated mechanical cleaning devices, thus simplifying the cleaning process.

A second objective of the present invention is to enable removal of dirt and/or sand contaminated lubricant from the drive chain of for example, a bicycle or motorcycle, by concentrated spraying with a hose.

A third objective of the present invention is to allow frequent removal of contamination, dirt and/or sand, which are a primary cause of wear. Once clean, to then enable the reintroduction of the lubricant while the chain is still wet, and inhibiting any residual water from producing rust in the chain.

A fourth objective of the present invention is to provide a lubricant for a drive chain, for example, for a bicycle or motorcycle, that will persist and function as a lubricant under wet and dry conditions.

A fifth objective of the present invention is to provide a lubricant for a drive chain, for example, for a bicycle or motorcycle, that will resist washing off in wet conditions encountered during normal riding.

### I. DEFINITIONS

As used herein, unless otherwise defined, the term “duty cycle,” when referring to the drive chain for transferring power in a bicycle or motorcycle, means the ratio of operating time to the sum of the operating time+time to lubricate the chain by reapplying the coating.

As used herein, unless otherwise defined, the term “semi water-soluble lubricant,” when referring to the coating for the drive chain of a bicycle or motorcycle, means part of the coating is soluble in water and the remaining part is not soluble.

As used herein, unless otherwise defined, the term “wetting agent,” when referring to the semi water-soluble lubricant that includes a detergent or surfactant means part of the semi water-soluble lubricant is soluble in water in the interstices or pores of the drive chain, so the semi water-soluble lubricant is absorbed or wetted into interstices or pores of the drive chain of a bicycle or motorcycle.

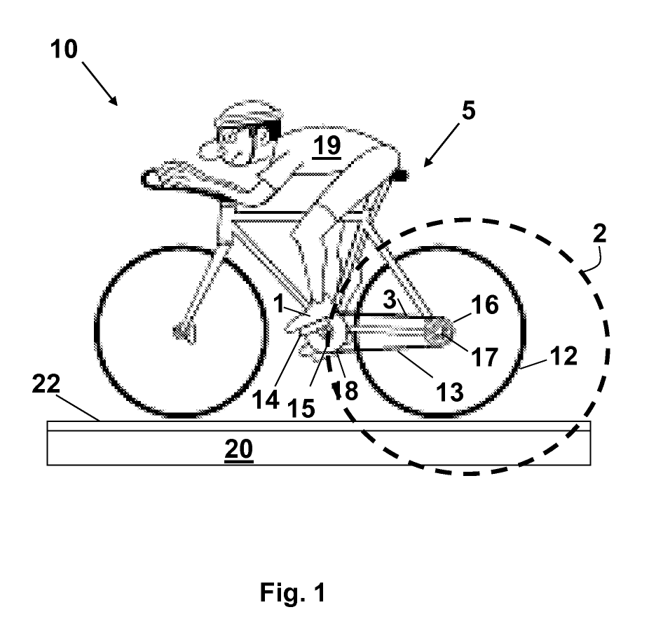

FIG. 1 depicts a side cross-sectional view of an apparatus 10, having a drive chain 13, such as the drive chain 13 of a bicycle or motorcycle, having a first surface 3, thereon, and the first surface 3 having a lubricant contaminated with dirt and/or sand, thereon.

The apparatus 10 comprises: a rider 20; having a right foot 2; a rear wheel 12, and a frame 5. The frame 5 is operably coupled to a rear gear 17, and a pedal gear 15. The rear gear 17, and a pedal gear 15 are operably coupled by the chain 13, therebetween a rear gear portion 16 of the chain 13 and a pedal gear portion 18 of the chain 13. The rear gear 17 is operably coupled to the rear wheel 12 of the apparatus 10. The frame 5 is operably coupled to a pedal gear 15 that is operably coupled to a pedal 14, upon which the left foot 1 of the rider 19 may rest.

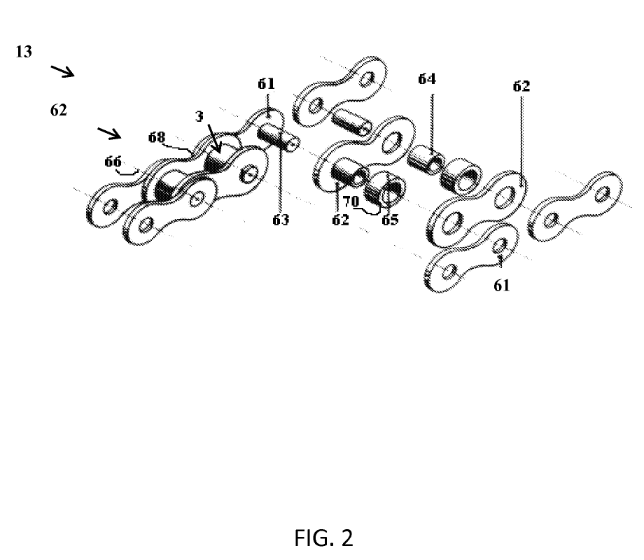

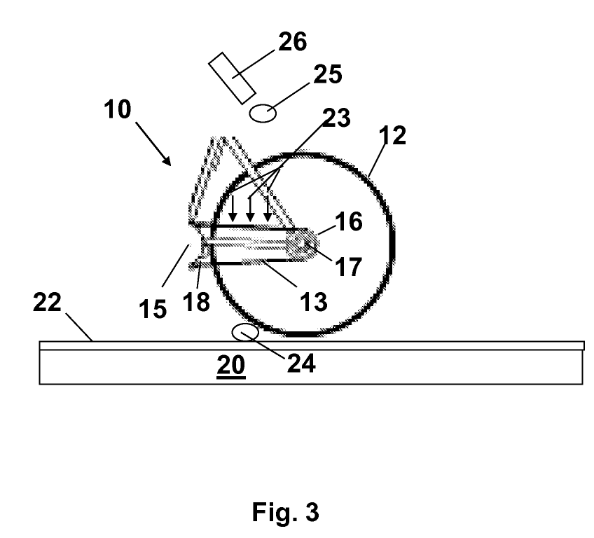

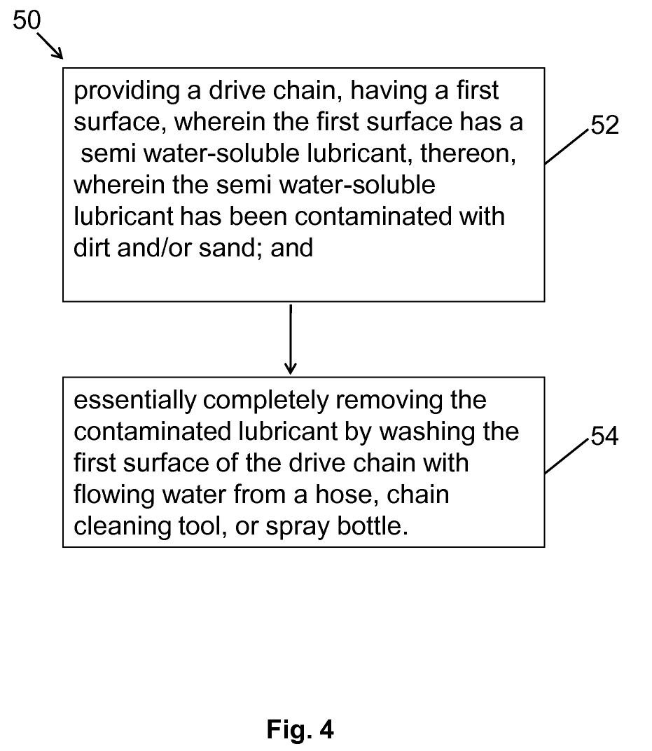

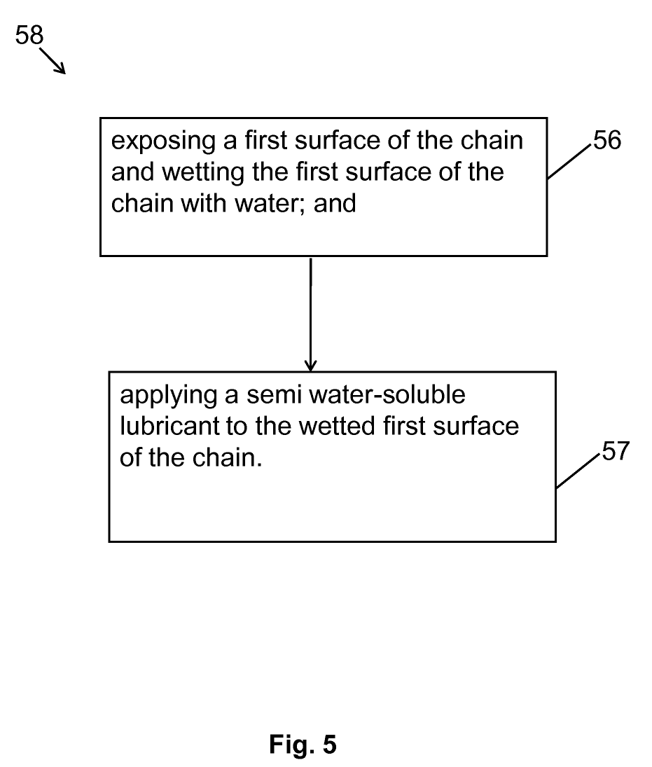

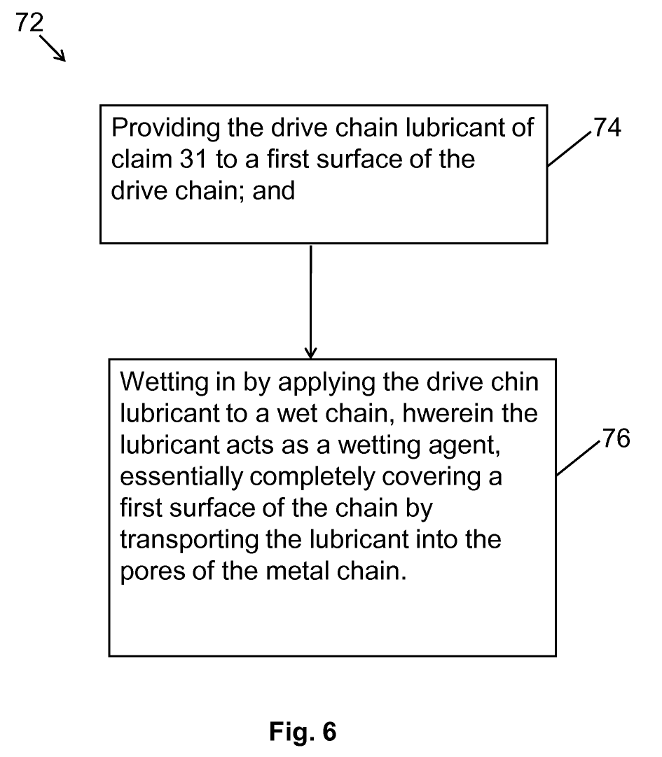

FIG. 2 depicts a front elevation view of the drive chain 13, comprising links 62, having outer plates 61, inner plates 62, pins 63, and rollers 65. Alignment of the parts of the links 62 are shown by alignment lines 66. Interstices 68, e.g. spaces between adjacent surfaces of the components of the links 62 may be advantageously filled with the semi water soluble lubricant of the present invention to reduce friction and prolong the duty cycle of the drive chain 13. The semi water-soluble lubricant may also fill pores 70 in the first surface 3 of the drive chain 13, thereby providing a smooth, uniform, low friction coating thereon. The drive chain 13 may be made of stainless steel, alloys of steel, or any appropriate metal.

FIG. 3 depicts an expanded view of the side cross-sectional view of the chain 13, illustrated in FIG. 1, wherein the contaminated lubricant has been washed off the first surface 3 of the chain 13. The apparatus 10 comprises a source 26, such as a hose or bottle, of solvent 25, such as water.

In FIG. 3, the solvent 25 is any polar liquid, such as water, and a continuous supply of clean solvent may be available from a source 26, such as a common garden hose or bottle 26. Forceful spraying onto the first surface 3 in the direction of the arrows 23 removes lubricant 24 that may be contaminated with dirt and/or sand from the first surface 3 of the chain 13 to form a layer 22 of solvent and contaminated lubricant 24 on the ground 20 upon which the apparatus 10 is supported or rides.

Water insoluble, oil based lubricants (synthetic oil, petroleum, based oil, mineral oil, and others) are used on many drive chain applications. Such lubricants work well, and provide long life and do not need to be reapplied often. The drawback to these is their tendancy to attract and hold dirt and sand, when used in a dirty environment. Riding a bicycle in sand is probably one of the worst conditions.

A variety of “dry” lubricants have been developed, that minimize the attraction and holding of dirt and sand. These are water insoluble, and use some type of wax in a solvent carrier. The two (2) main drawbacks to these types of lubricants are: 1) they tend to loose their lubricating qualities much quicker compared to their oil based counterparts, requiring frequent reapplicating, even within the time frame of a long ride, and 2) they are water insoluable and require a solvent or degreaser to clean the chain.

The lubricant of the present invention comprises a water miscible lubricating material, that will tend to stay on the chain during dry, and typical wet condition encountered on a bicycle, yet enable the removal with the direct blast from a water hose.

The general mindset among lubricant manufacturers, is that a water insoluble material is needed because water may be encountered during normal use. With little exception, the water exposure is limited to rain and splashing from puddles. Such use does not require a completely insoluble material. Hence, currently available lubricants are over-designed to the extent that they are very difficult to remove.

In addition, since the lubricant is miscible in water, the lubricant can be reintroduced onto a first surface 3 of a damp (with water) chain 13. A typical case when a wet chain is run through a paper towel, and the lubricant will combine with the remaining water, penetrating interstices in the first surface 3 of the chain 13, thereby inhibiting rust.

The present invention fulfills a long felt need to clean and lubricate a drive chain 13: 1) without removal of the chain 13 from the system; 2) without solvents or degreasers; and 3) without elaborate cleaning devices.

In one embodiment, the drive chain lubricant for power transfer, comprises a semi water-soluble lubricant; a water soluble rust inhibitor; and an effective amount of surfactant to make the mixture homogeneous.

The rust inhibitor may be an antioxidant. The antioxidants are selected from the

group consisting of sodium bisulfite, butylated hydroxytoluene, edetate disodium, benzyl alcohol, ascorbic acid, citric acid, malic acid, fumaric acid, lactic acid, and propionic acid, and mixtures thereof. In one embodiment, the antioxidant is sodium bisulfatebutylated hydroxytoluene, or edetate disodium, or a mixture thereof.

In one embodiment, the drive chain lubricant for power transfer, is a water miscible mixture comprising a hydrocarbon oil, such as mineral oil, and an effective amount of surfactant to make the mixture homogeneous. Appropriate surfactants for homogenizing the mixture are anionic surfactants (based on sulfate, sulfonate or carboxylate anions), such as Perfluorooctanoate (PFOA or PFO), Perfluorooctanesulfonate (PFOS), Sodium dodecyl sulfate (SDS), ammonium lauryl sulfate, and other alkyl sulfate salts, Sodium laureth sulfate, also known as sodium lauryl ether sulfate (SLES), Alkyl benzene sulfonate, Soaps, or fatty acid salts, cationic surfactants (based on quaternary ammonium cations), such as Cetyl trimethylammonium bromide (CTAB) e.g., hexadecyl trimethyl ammonium bromide, and other alkyltrimethylammonium salts, Cetylpyridinium chloride (CPC), Polyethoxylated tallow amine (POEA), Benzalkonium chloride (BAC), Benzethonium chloride (BZT), Zwitterionic (amphoteric), Dodecyl betaine, Cocamidopropyl betaine, Coco ampho glycinate, and nonionic surfactants, such as Alkyl poly(ethylene oxide), Alkylphenol poly(ethylene oxide), Copolymers of poly(ethylene oxide) and poly(propylene oxide) (commercially called Poloxamers or Poloxamines), Alkyl polyglucosides, including: Octyl glucoside, Decyl maltoside, Fatty alcohols, Cetyl alcohol, Oleyl alcohol, Cocamide MEA, cocamide DEA, Polysorbates: Tween 20, Tween 80 and Dodecyl dimethylamine oxide.

### EXAMPLE 1

Once a week, or every 200 miles (whichever comes first) the drive chain 13 should be lubricated. In the present example, the apparatus 10, depicted in FIG. 1, and described herein, has a first surface 3, and the first surface 3 has a lubricant contaminated with dirt and/or sand, thereon. The contaminated lubricant is essentially completely removed by utilizing the method 50.

FIG. 4 depicts a method 50 for washing a drive chain 13. In a step 52, contaminated lubricant 24 is essentially completely removed from the first surface 3 of the chain 13.

In a step 52 of the method 50, a drive chain 13 is provided, the drive chain 13 having a first surface 3. The first surface 3 has a semi water-soluble lubricant 24, thereon, wherein the semi water-soluble lubricant 24 has been contaminated with dirt and/or sand.

In a step 54 of the method 50, the contaminated lubricant 24 is essentially completely removed by washing the first surface 3 of the drive chain 13 with flowing water 25 from a water source 26, e.g., a hose, a chain cleaning tool, or a spray bottle.

The semi water-soluble lubricant is applied as in the method 58, or the method 72, as follows:

FIG. 5 depicts a method 58 for lubricating the drive chain 13, wherein the drive chain 13 is for power transfer. In the step 56 of a method 58 for lubricating a drive chain 13, a first surface 3 of the drive chain 13 is exposed and the first surface 3 of the chain 13 is wetted with water 25. In a step 57 of a method 58 uncontaminated semi water soluble lubricant is applied to the first surface 3 of the drive chain 13, in the direction of the arrows 23.

In the step 56, the semi water-soluble lubricant is distributed over the first surface 3 of the chain 13, so the semi water-soluble lubricant mixes with the water 25 and diffuses into the water 25 in the interstices 68 or pores 70 in the first surface 3 and between links 62 of the chain 13.

In the step 56 of the method 58 the chain 13 is air dried after the semi water-soluble lubricant has been distributed over the first surface 3 of the chain 13.

FIG. 6 depicts a method 72 for coating a drive chain 13 for power transfer. In a step 74, the semi water-soluble drive chain lubricant is wetted in by applying the drive chain lubricant to a wet chain 13. In the step 74 the semi water-soluble lubricant acts as a wetting agent, essentially completely covering a first surface of the chain by transporting the lubricant into the interstices 68 or pores 70 in the first surface 3 and between links 62 of the chain 13.

A duty cycle for the drive chain 13 is calculated according to formula (1):

Duty Cycle=Time in Operation/(Time in Operation+Time for Washing and Replacing the Lubricant) Formula (1)

In Example 1, a cyclist traveled approximately 100 miles, over a period of 8 hours, during intermittent rain, i.e., typical “wet” weather conditions for cycling, using a bicycle, the drive chain 13 for which was lubricated with the non water-soluble lubricant of the present invention. The cyclist replaced the lubricant on the drive chain at the conclusion of the trip, using the washing and lubricating steps 50 and 58 or 70, as depicted and described, herein. The washing and lubricating methods required about 0.0833 hrs.

In Example 2, a cyclist traveled approximately 100 miles, over a period of 8 hours, during intermittent rain, i.e., typical “wet” weather conditions for cycling, using the bicycle used in Example 1, but this time the drive chain 13 was lubricated with non water-soluble lubricant. The cyclist replaced the lubricant on the drive chain at the conclusion of the trip, using the washing and lubricating steps 50 and 58 or 70, as depicted and described, herein. The washing and lubricating methods required about 0.333 hrs.

Comparison of the duty cycles of the drive chain 13 for examples 1 and 2, as calculated by formula 1, shows the duty cycle of the chain lubricated with the semi water-soluble lubricant was essentially the same as the duty cycle of the chain lubricated with non water-soluble lubricant, i.e., from about 0.9959 to about 0.9836. However, the cyclist advantageously washed and lubricated the drive chain having the semi-water soluble lubricant, thereon, more quickly than the drive chain having the non water-soluble lubricant, thereon.

In addition, comparison of the duty cycles of examples 1 and 2 shows the duty cycle, as calculated by formula (1) of the drive chain 13 coated with the semi water soluble lubricant is not shortened by wet conditions normally encountered by the bicycle or motorcycle, based on the duty cycle a drive chain 13 coated with a non water-soluble lubricant operated under similar wet conditions.

In one embodiment, the drive chain 13 is for a bicycle or motorcycle.

In one embodiment, the lubricant can be washed off the first surface 3 of the drive chain 13 with water 25 from a source 26 having a hose spray nozzle.

In one embodiment, the lubricant will tend not to be washed off the first surface 3 of the drive chain 13 in wet conditions normally encountered by a bicycle.

In one embodiment, the lubricant is composed of a combination of a detergent and a lubricating oil.

In one embodiment, the detergent is liquid detergent.

In one embodiment, the detergent is any emulsifying agent, when combined with a non-water soluable oil.

In one embodiment, the detergent is derived from natural sources.

In one embodiment, the detergent is biodegradeable.

In one embodiment, the detergent is nontoxic.

In one embodiment, the lubricating oil is not soluble in water.

In one embodiment, the lubricating oil is a synthetic oil.

In one embodiment, the lubricating oil is a petroleum based.

In one embodiment, the lubricant is mineral oil.

In one embodiment, the lubricant is an emulsion composed of a combination of an emulsifying agent and a lubricating material.

In one embodiment, the emulsifying agent is liquid detergent.

In one embodiment, the lubricant is composed of a combination of a detergent and a lubricating wax.

In one embodiment, the wax is petroleum based.

In one embodiment, the wax is silicone based.

The foregoing description of the embodiments of this invention has been presented for purposes of illustration and description. It is not intended to be exhaustive or to limit the invention to the precise form disclosed, and obviously, many modifications and variations are possible.

I claim:

1. A coating for the drive chain of a bicycle or motorcycle, comprising a semi water-soluble lubricant.

2. The coating of claim 1, wherein the semi water-soluble lubricant comprises a detergent and either a petroleum based lubricant, a synthetic based oil, a silicone based lubricant or a mixture of petroleum and silicone based lubricants.

3. The coating of claim 2, wherein the petroleum based lubricant is selected from the group consisting of paraffin oil, paraffin wax, mineral oil, petroleum based grease, and petroleum based wax, and the silicone based lubricant is selected from the group consisting of silicone oil, silicone grease, and silicone wax.

4. The coating of claim 1, wherein the lubricant is essentially completely removed using a chain cleaning tool with water as the only solvent.

5. The coating of claim 1, wherein a duty cycle of the drive chain coated with the semi water soluble lubricant is not shortened by wet conditions normally encountered by the bicycle or motorcycle, based on the duty cycle a drive chain coated with a non water-soluble lubricant operated under similar wet conditions.

6. The coating of claim 1, wherein the lubricant is essentially completely miscible with water, so the lubricant can be essentially completely removed from the drive chain with water from a hose spray nozzle.

7. The coating of claim 1, comprising a rust inhibitor.

8. The coating of claim 8, wherein the rust inhibitor is an antioxidant.

9. The coating of claim 8, wherein the antioxidants are selected from the group consisting of sodium bisulfite, butylated hydroxytoluene, edetate disodium, benzyl alcohol, ascorbic acid, citric acid, malic acid, fumaric acid, lactic acid, and propionic acid, and mixtures thereof.

10. The coating of claim 9, wherein the antioxidant is sodium bisulfite, butylated hydroxytoluene, or edetate disodium, or a mixture thereof.

11. A drive chain lubricant, wherein the drive chain is for power transfer, comprising:
a water miscible mixture comprising: a synthetic oil, a hydrocarbon or silicone; and
an effective amount of surfactant to make the mixture homogeneous.

12. The drive chain lubricant of claim 11, wherein the hydrocarbon is mineral oil.

13. The drive chain lubricant of claim 11, wherein the surfactant is an anionic surfactant.

14. The drive chain lubricant of claim 13, wherein the anionic surfactant is selected from the group consisting of alkyl or alkaryl sulfate, alkyl or alkaryl sulfonate or alkyl or alkaryl carboxylate anions.

15. The drive chain lubricant of claim 12, wherein the anionic surfactant is selected from the group consisting of perfluorooctanoate (PFOA or PFO), perfluorooctanesulfonate (PFOS), Sodium dodecyl sulfate (SDS), ammonium lauryl sulfate, sodium lauryl ether sulfate (SLES), and alkyl benzene sulfonate.

16. The drive chain lubricant of claim 11, wherein the surfactant is a soap or fatty acid salt.

17. The drive chain lubricant of claim 11, wherein the surfactant is a cationic surfactant.

18. The drive chain lubricant of claim 15, wherein the cationic surfactant is an alkyltrimethylammonium salt.

19. The drive chain lubricant of claim 18, wherein the alkyltrimethylammonium salt is Cetyl trimethylammonium bromide (CTAB).

20. The drive chain lubricant of claim 17, wherein the cationic surfactant is selected from the group consisting of Cetylpyridinium chloride (CPC), Polyethoxylated tallow amine (POEA), Benzalkonium chloride (BAC), Benzethonium chloride (BZT), Zwitterionic (amphoteric), Dodecyl betaine, Cocamidopropyl betaine, and Coco ampho glycinate.

21. The drive chain lubricant of claim 11, wherein the surfactant is a nonionic surfactant, selected from the group consisting of alkyl poly(ethylene oxide), Alkylphenol poly(ethylene oxide), Copolymers of poly(ethylene oxide) and poly(propylene oxide) (commercially called Poloxamers or Poloxamines), and alkyl polyglucosides.

22. The drive chain lubricant of claim 21, wherein the alkyl polyglucoside is selected from the group consisting of octyl glucoside, decyl maltoside, fatty alcohols, cetyl alcohol, oleyl alcohol, cocamide MEA, cocamide DEA, polysorbates: Tween 20, Tween 80 and dodecyl dimethylamine oxide.

23. The drive chain lubricant of claim 11, wherein the surfactant is liquid detergent.

24. The drive chain lubricant of claim 11, comprising a rust inhibitor.

25. The drive chain lubricant of claim 23, wherein the rust inhibitor is an antioxidant.

26. The drive chain lubricant of claim 24, wherein the antioxidants are selected from the group consisting of sodium bisulfite, butylated hydroxytoluene, edetate disodium, benzyl alcohol, ascorbic acid, citric acid, malic acid, fumaric acid, lactic acid, and propionic acid, and mixtures thereof.

27. The drive chain lubricant of claim 24, wherein the antioxidant is sodium bisulfite, butylated hydroxytoluene, or edetate disodium, or a mixture thereon.

28. A method for washing a drive chain, wherein the drive chain is for power transfer, comprising:
providing a drive chain, having a first surface, wherein the first surface has a semi water-soluble lubricant, thereon, wherein the semi water-soluble lubricant has been contaminated with dirt and/or sand; and
essentially completely removing the contaminated lubricant by washing the first surface of the drive chain with flowing water from a hose, chain cleaning tool, or spray bottle.

29. A method for lubricating a drive chain, wherein the drive chain is for power transfer, comprising:
exposing a first surface of the chain and wetting the first surface of the chain with water; and
applying a semi water-soluble lubricant to the wetted first surface of the chain.

30. The method of claim 28, comprising distributing the semi water-soluble lubricant over the first surface of the chain, so the semi water-soluble lubricant mixes with the water and diffuses into the water in the interstices or pores in the first surface and between links of the chain.

31. The method of claim 29, wherein the chain is air dried after the semi water-soluble lubricant has been distributed over the first surface of the chain.

32. A drive chain lubricant, wherein the drive chain is for power transfer, comprising:
a semi water-soluble lubricant;
a water soluble rust inhibitor; and
an effective amount of surfactant to make the mixture homogeneous.

33. A method of coating a drive chain for power transfer, comprising:
providing the drive chain lubricant of claim 31 to a first surface of the drive chain; and
wetting in by applying the drive chain lubricant to a wet chain, wherein the lubricant acts as a wetting agent, essentially completely covering a first surface of the chain by transporting the lubricant into the pores of the metal chain.
